(19) United States
(12) Patent Application Publication
(10) Pub. No.: US 2009/0284464 A1
(43) Pub. Date: Nov. 19, 2009

(54) PROJECTION IMAGE DISPLAY APPARATUS

(75) Inventors: Yasuhide Kogo, Osaka (JP); Takehiko Takimoto, Kakogawa-city (JP); Naoyuki Ikeda, Osaka (JP); Kiyoko Tsuji, Osaka (JP); Yasuko Teragaki, Gifu-city (JP); Masutaka Inoue, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/468,398

(22) Filed: May 19, 2009

(30) Foreign Application Priority Data
May 19, 2008 (JP) 2008-131326

(51) Int. Cl. G09G 5/00

(52) U.S. Cl. 345/156; 348/143

(57) ABSTRACT

The projection image display apparatus includes an image light generator and a projection optics. The projection optics includes a reflection mirror. The projection image display apparatus includes an image capture device configured to capture an image of a user facing the projection surface, a first acquisition unit configured to acquire captured image data from the image capture device, a second acquisition unit configured to acquire sample data independently of the captured image data, and an image controller configured to control an image to be displayed on the projection surface on the basis of the captured image data and the sample data.

### CROSS REFERENCE TO RELATED APPLICATIONS

This application is based upon and claims the benefit of priority from prior Japanese Patent Application No. 2008-131326, filed on May 19, 2008; the entire contents of which are incorporated herein by reference.

### BACKGROUND OF THE INVENTION

1. Field of the Invention

The present invention relates to a projection image display apparatus including a projection optics configured to project image light.

2. Description of the Related Art

Heretofore, there has been known a projection image display apparatus which includes an imager modulating light emitted from a light source, and a projection lens projecting light emitted from the imager on a projection surface (screen).

In order to display a magnified image on the screen, a distance between the projection lens and the screen needs to be long. To make this possible, a projection display system has been proposed that is designed to shorten a distance between a projection image display apparatus and a screen by using a reflection mirror reflecting light emitted through a projection lens, on the screen (for example, see Japanese Patent Publication No. 2006-235516 (claim 1, FIG. 1 etc.)).

When an attempt is made to shorten the distance between the projection image display apparatus and the screen, the projection image display apparatus inevitably comes closer to the screen and consequently comes into the user's view. To avoid this, projection needs to be performed obliquely from above, below, or a side of the screen. For example, in the projection display system described above, an imager and a projection optics are shifted relative to each other in the vertical direction, and a concave mirror is used as the reflection mirror, in order to shorten the projection distance and perform the oblique projection.

Meanwhile, as a new installation/projection method of the projection image display apparatus, which is designed to shorten the projection distance, conceivable is, for example, a method of installing the projection image display apparatus on a floor or a desk and projecting an object on the floor or the desk. However, not much attention is paid to how and in what occasion such a new installation/projection method can be used.

### SUMMARY OF THE INVENTION

A projection image display apparatus according to a first aspect of the present invention includes an image light generator (image light generator 200) configured to generate image light and a projection optics (projection optics 300) configured to project the image light on a projection surface. The projection optics has a reflection mirror (reflection mirror 320) configured to reflect the image light emitted from the image light generator. The projection image display apparatus includes an image capture device (image capture device 500) configured to capture an image of a user facing the projection surface, a first acquisition unit (first acquisition unit 252) configured to acquire captured image data from the image capture device, a second acquisition unit (second acquisition unit 253) configured to acquire sample data independently of the captured image data, and an image controller (image controller 254) configured to control an image to be displayed on the projection surface on the basis of the captured image data and the sample data.

According to the first embodiment, the image controller controls the image to be displayed on the projection surface on the basis of the captured image data and the sample data. That is, the projection image display apparatus displays a captured image formed of the captured image data and a sample image formed of the sample data on the projection surface. Accordingly, the user can easily know whether or not the captured image deviates from the sample image.

In the first aspect, the image controller superimposes the captured image formed of the captured image data on the sample image formed of the sample data, on the projection surface.

In the first aspect, the projection image display apparatus further includes a size acquisition unit (size acquisition unit 251) configured to acquire the size of the user to be included in the captured image. On the projection surface, the image controller matches the size of the captured image and the size of the sample image with each other on the basis of the size of the user.

In the first aspect, the projection image display apparatus further includes a determination unit configured to determine a deviation degree between the captured image and the sample image.

In the first aspect, the image controller displays the deviation degree on the projection surface.

### BRIEF DESCRIPTION OF THE DRAWINGS

FIG. 1 is a view showing a projection image display apparatus 100 according to a first embodiment;

FIG. 2 is a view showing a configuration of an image light generator 200 and a projection optics 300 according to the first embodiment;

FIG. 3 is a block diagram showing a control unit 250 according to the first embodiment;

FIG. 4 is a view showing a display example according to the first embodiment;

FIG. 5 is a flowchart showing operation of the projection image display apparatus 100 according to the first embodiment;

FIG. 6 is a block diagram showing a control unit 250A according to a second embodiment;

FIG. 7 is a view showing a size acquisition method according to the second embodiment;

FIG. 8 is a view showing a size adjustment method according to the second embodiment;

FIG. 9 is a block diagram showing a control unit 250B according to a third embodiment; and

FIG. 10 is a view showing a deviation degree according to the third embodiment.

### DESCRIPTION OF THE PREFERRED EMBODIMENTS

A projection image display apparatus according to embodiments of the present invention will be described below with reference to the drawings. In the following description of the drawings, the same or similar parts will be denoted by the same or similar reference numerals.

However, it should be noted that the drawings are schematic and that proportions of dimensions and the like are different from actual ones. Thus, specific dimensions and the like should be determined by referring to the following description. Naturally, there are portions where relations or proportions of dimensions between the drawings are different.

### First Embodiment

### (Configuration of Projection Image Display Apparatus)

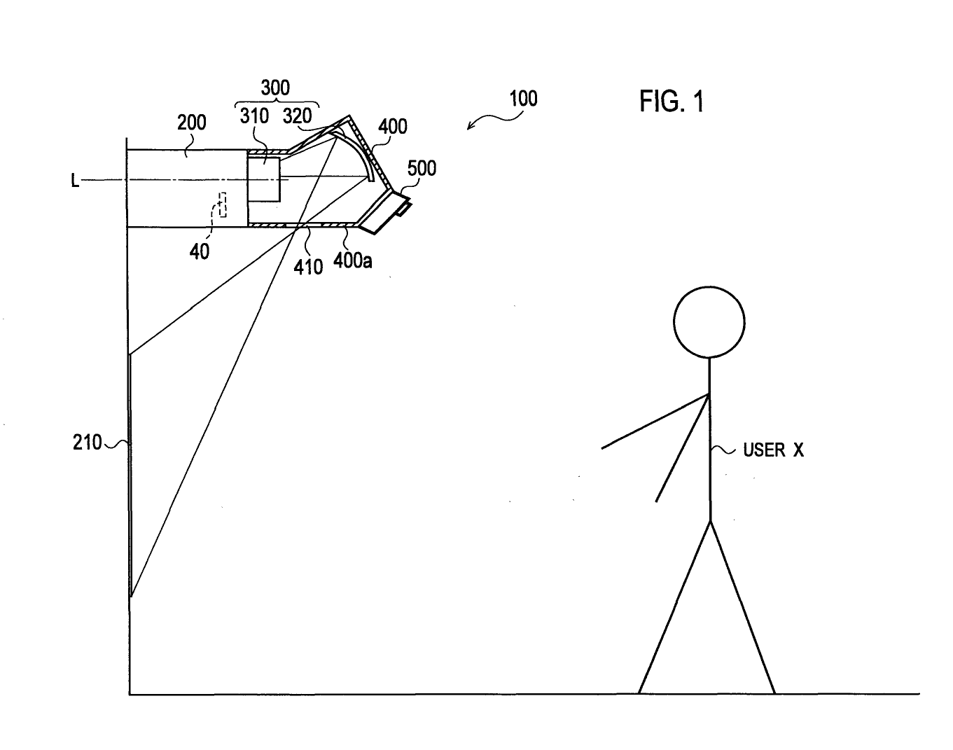

A configuration of a projection image display apparatus according to a first embodiment will be described by referring to the drawings. FIG. 1 is a view showing the configuration of a projection image display apparatus 100 according to the first embodiment.

As shown in FIG. 1, the projection image display apparatus 100 includes a casing 400 which houses an image light generator 200 and a projection optics 300. In the first embodiment, one portion of the casing 400 constitutes a protection cover 400a. In addition, the projection image display apparatus 100 has an image capture device 500. Note that, in the first embodiment, the projection image display apparatus 100 is installed on a wall surface or ceiling constituting a projection surface 210.

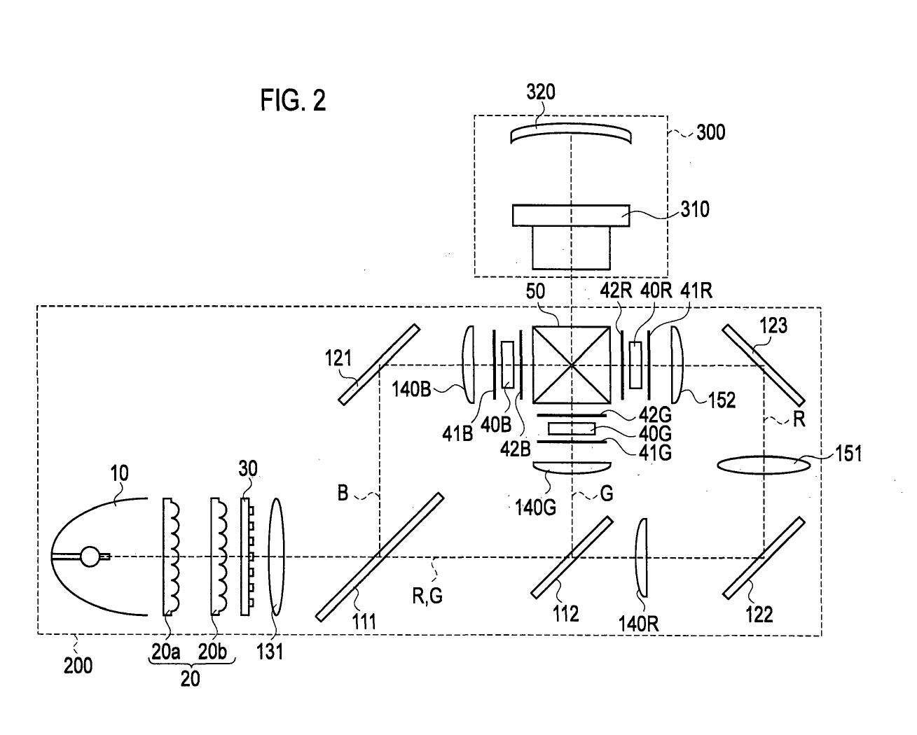

The image light generator 200 generates image light. Specifically, the image light generator 200 includes at least a display device 40 emitting the image light. The display device 40 is provided in a position shifted relative to an optical axis L of the projection optics 300. This shifted arrangement enables oblique projection. A reflective liquid crystal panel, a transmissive liquid crystal panel, a digital micromirror device (DMD), or the like can be used for the display device 40, for example. The image light generator 200 will be described in detail later (See FIG. 2).

The projection optics 300 projects image light emitted from the image optical generator 200. The projection optics 300 projects image light on the projection surface 210. Specifically, the projection optics 300 includes a projection lens 310 and a reflection mirror 320.

The projection lens 310 emits image light emitted from the image light generator 200 towards the reflection mirror 320.

The reflection mirror 320 reflects the image light emitted from the projection lens 310. The reflection mirror 320 concentrates and then magnifies the image light. The reflection mirror 320 is, for example, an aspheric mirror having a concave surface on the image light generator 200 side thereof.

The protection cover 400a protects the reflection mirror 320. The protection cover 400a is provided at least in an optical path of the image light reflected by the reflection mirror 320. The protection cover 400a includes a transmission region 410 through which the image light is transmitted.

In this manner, the projection optics 300 projects the image light transmitted through the transmission region 410 on the projection surface 210.

The image capture device 500 is a device which captures an image of a user X facing the projection surface 210. In the first embodiment, the image capture device 500 captures an image of the user X obliquely from above the user X. The user X practices, for example, movements of dancing or a martial art, while viewing the image displayed on the projection screen 210.

### (Configuration of Image Light Generator)

A configuration of the image light generator according to the present embodiment will be described with reference to the drawing. FIG. 2 is a view mainly showing the image light generator 200 and the projection optics 300 according to the first embodiment. The image light generator 200 includes, in addition to the configuration shown in FIG. 2, a power source circuit (not shown), an image signal processing circuit (not shown), and the like. Here, a case where the display device 40 is a transmissive liquid crystal display panel will be illustrated (hereinafter, the display device 40 will be also referred to as a liquid crystal panel 40).

The image light generator 200 includes a light source 10, a fly-eye lens unit 20, a PBS array 30, multiple liquid crystal panels 40 (liquid crystal panels 40R, 40G, and 40B), and a cross-dichroic prism 50.

The image light generator 200 includes a mirror group (dichroic mirror 111, dichroic mirror 112, reflection mirrors 121 to 123) and a lens group (a condenser lens 131, a condenser lens 140R, a condenser lens 140G, a condenser lens 140B, and relay lenses 151 and 152).

The light source 10 is, for example, an ultra-high pressure mercury lamp (UHP lamp) formed of a burner and a reflector. Light emitted from the light source 10 includes red, green and blue light components.

The fly-eye lens unit 20 equalizes the light emitted from the light source 10. In other words, the fly-eye lens unit 20 equalizes the amounts of light emitted from a central portion of the light source 10 and light emitted from a peripheral portion thereof. Specifically, the fly-eye lens unit 20 is formed of a fly-eye lens 20a and a fly-eye lens 20b.

Each of the fly-eye lenses 20a and 20b is formed of multiple microlenses. The light emitted from the light source 10 is guided by the microlenses to be incident on the whole surface of each display device 40.

The PBS array 30 aligns the polarization states of the light beams emitted from the fly-eye lens unit 20. In the first embodiment, the PBS array 30 adjusts the light beams emitted from the fly-eye lens unit 20 to P polarization.

The dichroic mirror 111 transmits the red light beam and the green light beam from among the light beams emitted from the PBS array 30. The dichroic mirror 111 reflects the blue light beam from among the light beams emitted from the PBS array 30.

The dichroic mirror 112 transmits the red light beam from among the light beams transmitted through the dichroic mirror 111. The dichroic mirror 112 reflects the green light beam transmitted through the dichroic mirror 111.

The reflection mirror 121 reflects the blue light beam to lead the blue light beam towards the liquid crystal panel 40B side. The reflection mirrors 122 and 123 reflect the red light beam to lead the red light beam towards the liquid crystal panel 40R side.

The condenser lens 131 is a lens which gathers white light emitted from the light source 10.

The condenser lens 140R makes the red light beam a substantially parallel beam so that the red light beam can be incident on the liquid crystal panel 40R; the condenser lens 140G makes the green light beam a substantially parallel beam so that the green light beam can be incident on the liquid crystal panel 40G; the condenser lens 140B makes the blue light beam a substantially parallel beam so that the blue light beam can be incident on the liquid crystal panel 40B.

The relay lenses 151 and 152 form an approximate image of the red light beam on the liquid crystal panel 40R while suppressing expansion of the red light beam.

The liquid crystal panel 40R modulates the red light beam by rotating the polarization direction of the red light beam. On the light-incident surface side of the liquid crystal panel 40R, a light-incident-side polarizing plate 41R is provided. The light-incident-side polarizing plate 41R transmits a light beam having one polarization direction (for example, P polarization) and shields a light beam having the other polarization direction (for example, S polarization). Meanwhile, on the light-emitting surface side of the liquid crystal panel 40R, a light-emitting side polarizing plate 42R is provided. The light-emitting side polarizing plate 42R shields the light beam having one polarization direction (for example, P polarization) and transmits the light beam having the other polarization direction (for example, S polarization).

Similarly, the liquid crystal panels 40G and 40B respectively modulate the green light beam and the blue light beam by rotating the polarization directions of the green light beam and the blue light beam. On the light-incident surface side of the liquid crystal panel 40G, a light-incident-side polarizing plate 41G is provided. On the light-emitting surface side of the liquid crystal panel 40G, a light-emitting side polarization panel 42G is provided. On the light-incident surface side of the liquid crystal panel 40B, a light-incident-side polarizing plate 41B is provided. On the light-emitting surface side of the liquid crystal panel 40B, a light-emitting side polarizing plate 42B is provided.

The cross-dichroic prism 50 combines light beams emitted from the liquid crystal panels 40R, 40G, and 40B. The cross-dichroic prism 50 emits the combined light beam to the projection lens 310 side.

### (Function of Projection Image Display Apparatus)

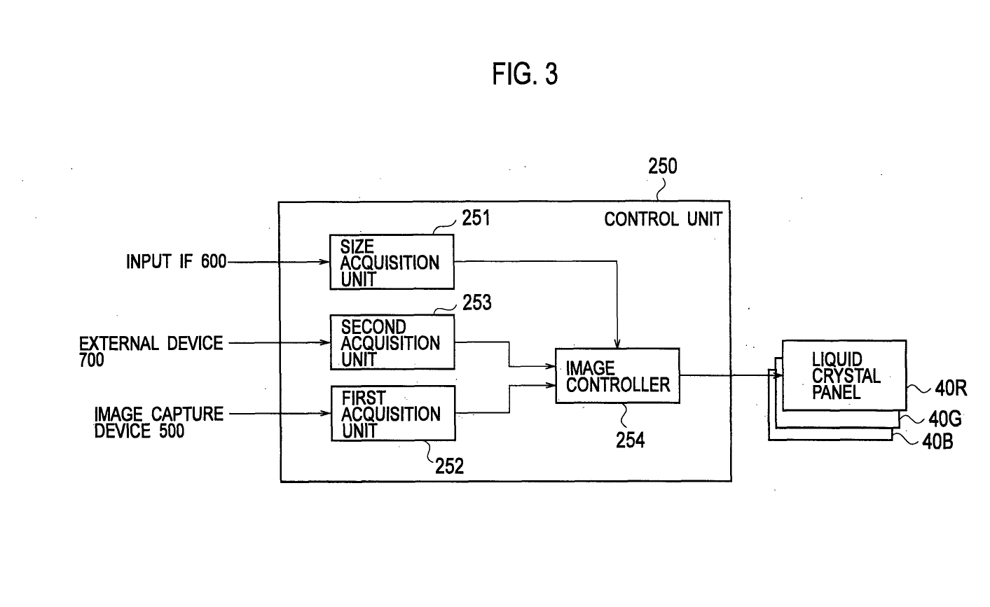

A function of the projection image display apparatus according to the first embodiment will be described below with reference to the drawing. FIG. 3 is a block diagram showing a controller 250 provided in the projection image display apparatus 100 according to the first embodiment. The controller 250 is provided in the image light generator 200.

As shown in FIG. 3, the controller 250 includes a size acquisition unit 251, a first acquisition unit 252, a second acquisition unit 253, and an image controller 254.

The size acquisition unit 251 acquires the size of a user X from an input IF 600 such as a keyboard. The size of the user X includes, for example, the figure (height and weight) of the user X.

The first acquisition unit 252 acquires captured image data from the image capture device 500. The captured image data is image data used for displaying a captured image which is captured by the image capture device 500. The captured image includes movements of the user X in practicing movements of a dance or a martial art, for example.

The second acquisition unit 253 acquires sample data from external equipment 700 such as DVD player. The sample data is image data used for displaying a sample image. The sample image includes model movements of an instructor demonstrating movements of dancing or a martial art.

Note that the second acquisition unit 235 may acquire sample data from a hard disk device, not from the external equipment. In addition, the second acquisition unit 253 may acquire the sample data through a network such as LAN or the like.

The image controller 254 controls an image to be displayed on the projection surface 210. That is, the image controller 254 controls the display devices 40 (liquid crystal panels 40R, 40G, and 40B).

Specifically, the image controller 254 superimposes a captured image formed by captured image data on a sample image formed by sample data. Specifically, the image controller 254 superimposes the movement of the user X (captured image) on the model movement of the instructor (sample image).

It is preferable here that the image controller 254 should match the size of the captured image and the size of the sample image with each other on the basis of the size of the user X acquired by the size acquisition unit 251. Specifically, the image controller 254 matches the figure of the user X with the figure of the instructor. Note that the figure of the instructor is known.

In addition, it is preferable that the image controller 254 superimpose the captured image on the sample image in such a manner that the head top of the user X and the head top of the instructor are at the same position.

The image controller 254 may display the captured image and the sample image side by side with each other, without superimposing the movement of the user X (captured image) on the model movement of the instructor (sample image). The user X can optionally perform switching between the superimposition display and the two-window display.

In the superimposition display, a captured image is superimposed on a sample image. In the two-window display, a captured image and a sample image are displayed side by side with each other.

### (Image Display Example)

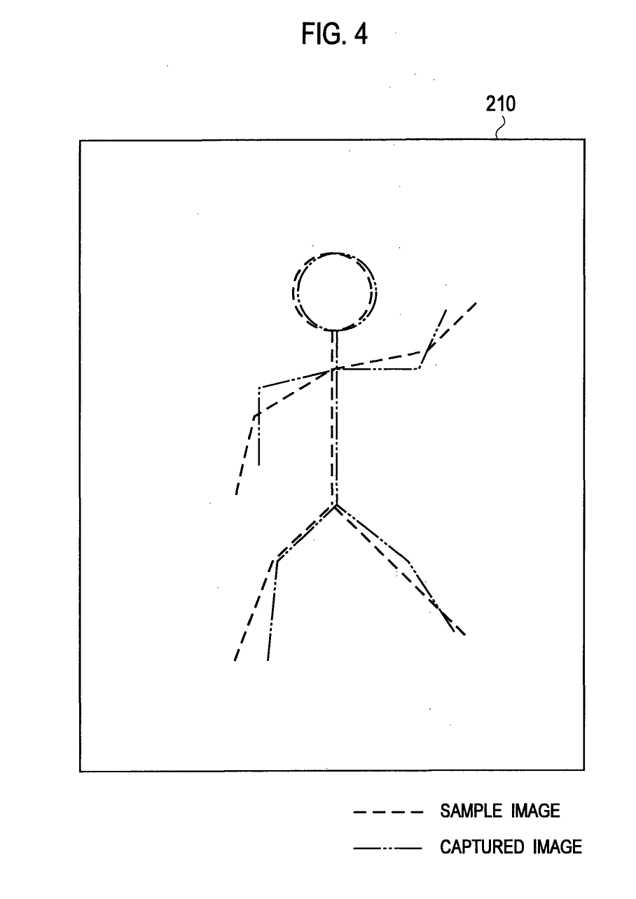

An image display example according to the present embodiment will be described below with reference to the drawing. FIG. 4 is a view showing an image display example according to the first embodiment.

As shown in FIG. 4, an image in which a captured image is superimposed on a sample image is displayed on the projection surface 210. In addition, the captured image (the size of the user X) and the sample image (the size of the instructor) are matched with each other.

### (Operation of Projection Image Display Apparatus)

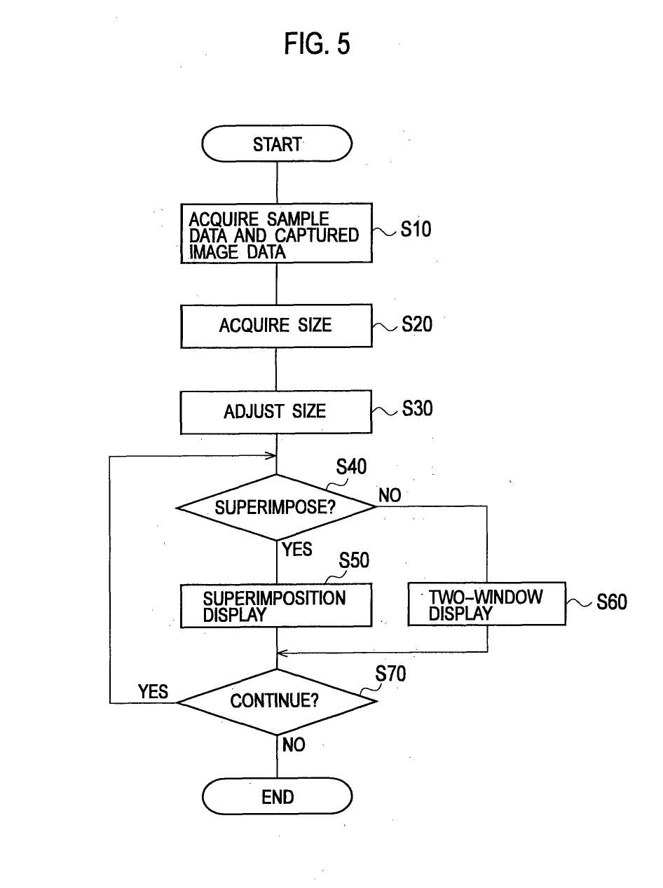

The operation of the projection image display apparatus according to the first embodiment will be described below with reference to the drawing. FIG. 5 is a flowchart showing the operation of the projection image display apparatus according to the first embodiment.

As shown in FIG. 5, in step S10, the projection image display apparatus 100 acquires sample data with the second acquisition unit 253, the user X moves in a series of postures, and, then the projection image display apparatus 100 acquires captured image data with the first acquisition unit 252. Alternatively, when moving, the user X may refer to a projected sample image formed by the sample data.

In step S20, the projection image display apparatus 100 acquires the size of the user X with the size acquisition unit 251.

In step S30, the projection image display apparatus 100 matches the figure of the user X and the figure of the instructor with each other on the basis of the size of the user X.

In step S40, the projection image display apparatus 100 determines if the superimposition display is selected. When the superimposition display is selected, the projection image display apparatus 100 proceeds to the process in step S50. When the superimposition display is not selected, the projection image display apparatus 100 proceeds to the process in step S60. As described above, the superimposition display and the two-window display are selected at user's option.

In step S50, the projection image display apparatus 100 displays the captured image and the sample image by superimposing the captured image formed of the captured image data on the sample image formed of the sample data. For example, the projection image display apparatus 100 matches the head top of the user X with the head top of the instructor to superimpose the captured image on the sample image.

In step S60, the projection image display apparatus 100 displays the captured image formed of the captured image data and the sample image formed of the sample data side by side with each other.

In step S70, the projection image display apparatus 100 determines whether or not to continue displaying the captured image. The display of the captured image may be terminated by an instruction of the user X or when the model movements of the instructor are finished. When determining to continue displaying the captured image, the projection image display apparatus 100 returns to the process in step S40. When determining not to continue displaying, the projection image display apparatus 100 finishes a series of the processes.

Note that when the display of the captured image is continued, the projection image display apparatus 100 continuously acquires the captured image data.

If the sizes of the captured image and the sample image do not match with each other, it goes without saying that the processes in steps S20 and S30 can be omitted.

### (Advantages and Effects)

In the first embodiment, the image controller 254 superimposes a captured image formed of captured image data on a sample image formed of sample data. Accordingly, the user X can easily understand whether or not the movements of the user X deviate from the model movements of the instructor.

The image controller 254 matches the size of the captured image and the size of the sample image with each other on the basis of the size of the user X acquired by the size acquisition unit 251. Accordingly, the user X can easily understand how much the movements of the user X deviate from the model movements of the instructor. Thus, the user X can check his/her own postures.

### Second Embodiment

A second embodiment of the present embodiment will be described below with reference to the drawings. In the following description, differences between the first and second embodiments will be mainly described.

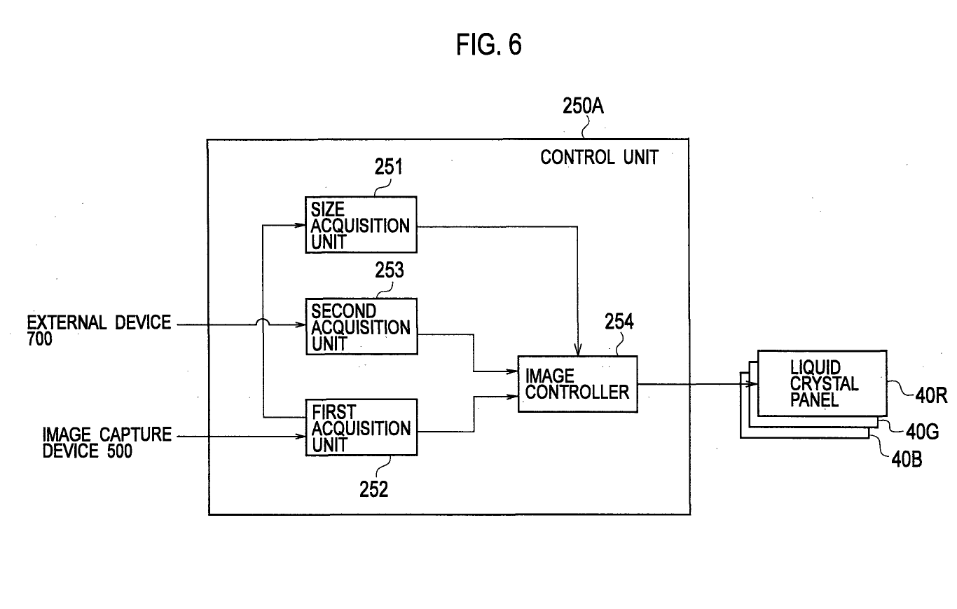

In the first embodiment, the size acquisition unit 251 acquires the size of the user X from the input IF 600 such as a keyboard. By contrast, in the second embodiment, a size acquisition unit 251 acquires the size of a user X on the basis of captured image data acquired from an image capture device 500 by a first acquisition unit 252. Note that, in a controller 250A according to the second embodiment, as shown in FIG. 6, the size acquisition unit 251 is connected to a first acquisition unit 252.

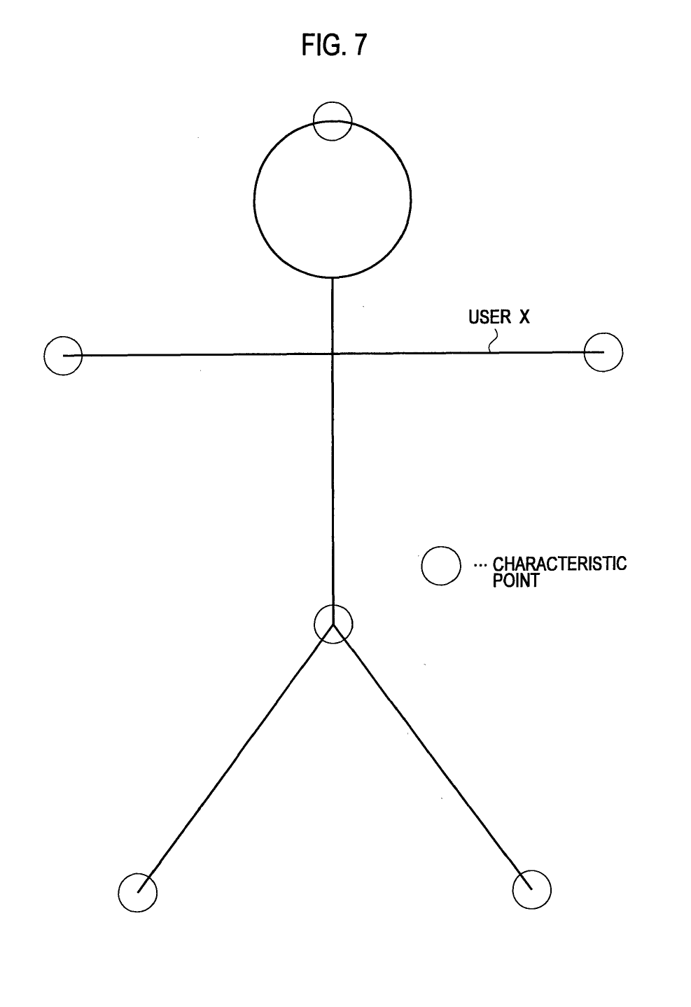

Specifically, as shown in FIG. 7, the image capture device 500 captures an image of the user X with both arms and legs being opened. The size acquisition unit 251 specifies characteristic points, such as the head top, fingertips of both hands, toes of feet, and crotch of the user X. The size acquisition unit 251 acquires the arm length, leg length, and height of the user X.

However, characteristic points are not limited to the head top, fingertips of both hands, toes of feet and the like of the user X. The characteristic points may include portions specifying the shape of the user X, the portions including the joint regions such as elbows and knees, the chest region, the abdomen region, and the lumber region. In addition, a characteristic point may be selected by the user X as needed.

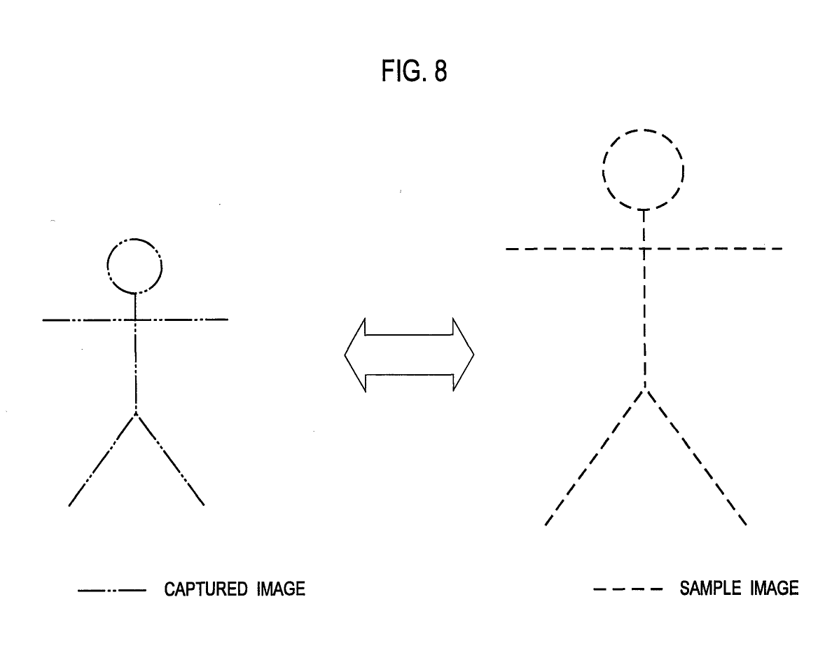

As described above, the image controller 245 matches the figure of the user X and the figure of the instructor with each other. As shown in FIG. 8, the image controller 254 may match the figure of the user X with the figure of the instructor or may match the figure of the instructor with the figure of the user X.

For example, the image controller 254 matches the figure of the user X with the figure of the instructor by enlarging or reducing the figure (image) of the user X so that the characteristic points of the user X and the characteristic points of the instructor overlap. Alternatively, the image controller 254 matches the figure of the instructor with the figure of the user X by enlarging or reducing the figure (image) of the instructor so that the characteristic points of the user X and the characteristic points of the instructor overlap.

### (Advantages and Effects)

According to the second embodiment, the size acquisition unit 251 acquires the size of the user X on the basis of the captured image data. Accordingly, the user X can save labor of inputting his/her size.

In addition, by increasing the number of the characteristic points, the accuracy in specifying the figure of the user X is improved and the accuracy in matching the figure of the user X and the figure of the instructor with each other is improved.

### Third Embodiment

A third embodiment of the present invention will be described below with reference to the drains. In the following description, differences between the first and third embodiments will be mainly described.

In the third embodiment, a projection image display apparatus 100 determines what degree movements of a user X deviate from model movements of an instructor (hereinafter referred to as a deviation degree). The projection image display apparatus 100 displays the deviation degree on a projection surface 210.

### (Configuration of Projection Image Display Apparatus)

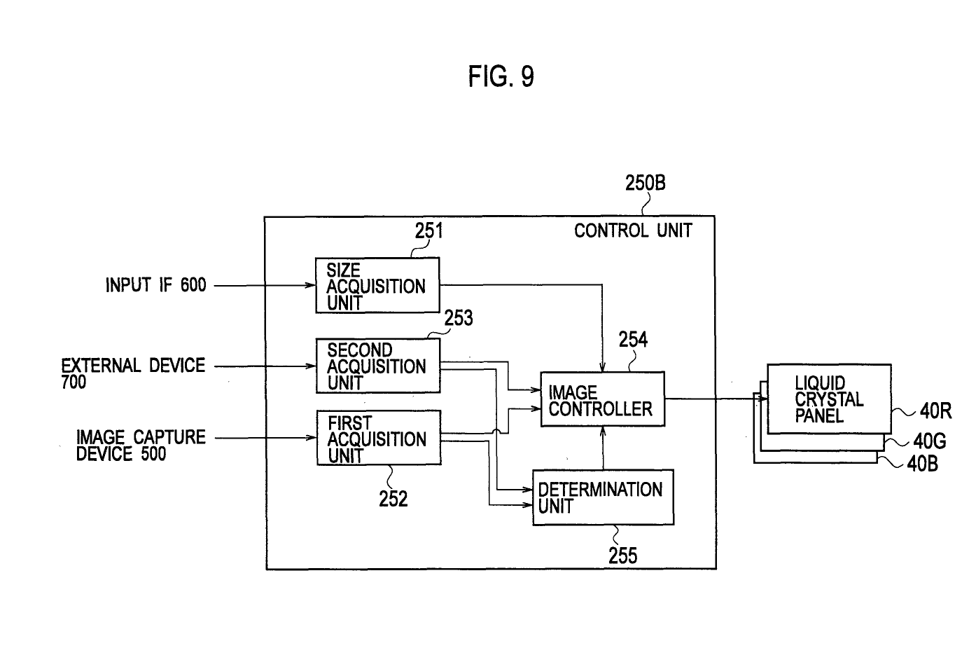

A function of the projection image display apparatus according to the third embodiment will be described below with reference to the drawing. FIG. 9 is a block diagram showing a control unit 250B provided in the projection image display apparatus 100 according to the third embodiment. The control unit 250B is provided in an image light generator 200. In FIG. 9, the same components as those in FIG. 3 are denoted by the same reference numerals.

As shown in FIG. 9, the control unit 250B includes a determination unit 255 in addition to the configuration shown in FIG. 3.

The determination unit 255 determines what degree the movements of the user X deviate from the model movements of the instructor (hereinafter referred to as a deviation degree). Specifically, the determination unit 255 determines the deviation degree in the following procedures.

Firstly, the determination unit 255 specifies characteristic points of the user X and the instructor. The characteristic points include the head top, fingertips of both hands, toes of feet, crotch, and joints such as elbows or knees.

Secondly, the determination unit 255 calculates a motion vector in each characteristic point. The motion vector can be calculated by an approach such as block matching.

Thirdly, the determination unit 255 calculates a difference between the motion vector of the user X and the motion vector of the instructor. The determination unit 255 acquires the difference between the motion vectors as a deviation degree.

It is preferable here that the difference between the motion vectors be initialized when the user X starts the movements or the difference between the motion vectors exceeds a predetermined threshold. That is, the deviation degree is the difference between the motion vectors. Accordingly, it is not necessary to consider an amount of mismatch between the characteristic points of the user X and the instructor (initial mismatch amount) at the time when the user X starts the operation.

If the characteristic points or motion vectors of the instructor are known, specifying the characteristics of the instructor and calculating the motion vectors of the instructor may be omitted.

The image controller 254 displays the deviation degree determined by the determination unit 255, on the projection surface 210. The deviation degree may be shown by a numerical value (score) or may be shown by a length of a vector (arrow). Note that it is preferable that a numerical value (score) becomes larger as the deviation degree becomes smaller. It is also preferable that the length of a vector (arrow) becomes shorter as the deviation degree becomes smaller. The direction of the vector (arrow) may be a direction in which the movements of the user X deviate from the movements of the instructor (that is, a deviation direction) or a direction in which the movements of the user X come closer to the model movements of the instructor (that is, a movement correcting direction).

The image controller 254 calculates the deviation degree in a series of the movements of the user X. The accumulation result may be displayed in a score or the like. The image controller 254 may display the calculation result when a series of the movements of the user X is finished or may display the accumulation result while updating the calculation result in a series of the movements of the user X.

### (Image Display Example)

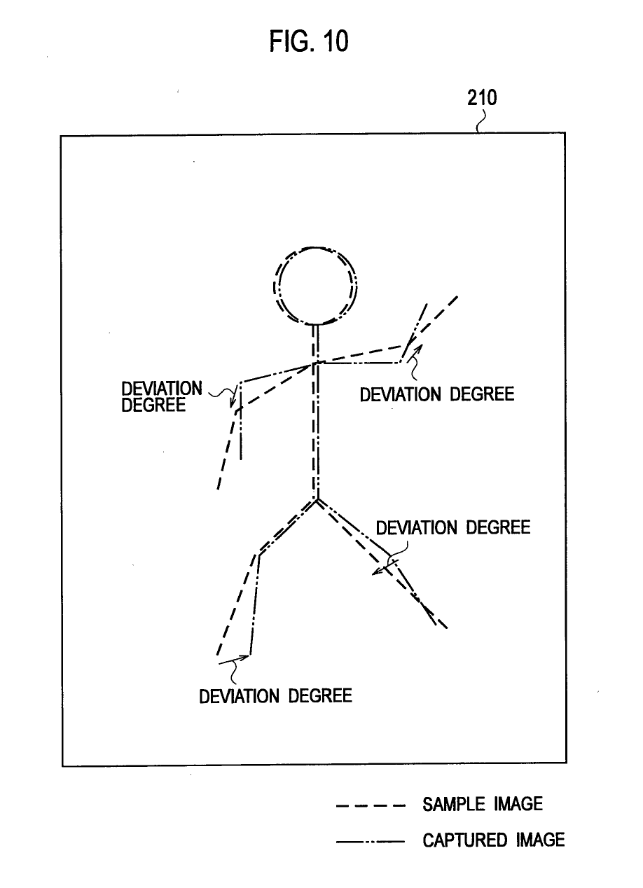

An example of a display image according to the third embodiment will be described below with reference to the drawing. FIG. 10 is a view showing an image display example according to the third embodiment.

As shown in FIG. 10, an image in which a captured image is superimposed on a sample image is displayed on the projection surface 210. Here, the deviation degree is displayed on the projection surface 210. In FIG. 8, a vector (arrow) showing the movement correcting direction is displayed as the deviation degree.

### (Advantages and Effects)

In the third embodiment, the determination unit 255 determines what degree the movements of the user X deviate from the model movements of the instructor (hereinafter, a deviation degree). The deviation degree is displayed on the projection surface 210. Accordingly, it can be easily understood that what degree the movements of the user X deviate from the model movements of the instructor.

### Other Embodiments

The present invention has been described by the above-described embodiments. However, it should be understood that the description and drawings constituting one part of this disclosure do not limit the present invention. Various alternative embodiments, examples, and operational techniques will be apparent from this disclosure for those skilled in the art.

While not particularly described in the above embodiments, the projection cover 400a may have an opening communicating with the projection surface 210 from the reflection mirror 320. The transmission region 410 may be such an opening.

While not particularly described in the above embodiments, at least one portion of the protection cover 400a may be formed of a light transmissive member such as a transparent resin or glass. The transmission region 410 may be formed of such a light transmissive member.

While not particularly described in the above embodiments, it is preferable that the transmission region 410 be provided in a vicinity of a position in which image light is gathered by the reflection mirror 320. With this configuration, the transmission region 410 may be reduced in size. Accordingly, for example, if the transmission region 410 is an opening, dusts can hardly enter inside the projection cover 400a, or if the transmission region 410 is formed of a light transmissive member, the light transmissive member is hardly damaged.

In the above-described embodiments, there has been given of the case in which an aspherical mirror is used as the reflection mirror 320. However, the reflection mirror 320 is not limited to this. For example, a free-form surface mirror may be used as the reflection mirror 320. Also, if any efforts are made in adjusting an aberration or a resolution, a spherical mirror may be used as the reflection mirror 320.

In the above-described embodiments, the description has been given of the case (three-plate type) in which the multiple display devices 40 are used in the configuration of the image light generator 200. However, the configuration of the image light generator 200 is not limited to this. In the configuration of the image light generator 200, a single display device 40 may be used (single plate type).

While not particularly described in the above embodiments, it is preferable that the image controller 254 match the eye point of the captured image with the eye point of the sample image on the basis of the inclination of the image capture device 500. That is, it is preferable that the image controller 254 has a keystone correction function.

In the above-described embodiments, the projection image display apparatus 100 is installed on a wall surface or ceiling. However, the installation of the projection image display apparatus 100 is not limited to this. Specifically, the projection image display apparatus 100 may be installed on a floor surface.

According to the above embodiments, the distance between the projection image display apparatus 100 and the projection surface 210 is shortened by providing the reflection mirror 320. This makes it possible: to prevent image light from being blocked by a person or thing coming between the projection image display apparatus 100 and the projection surface 210; and to reduce the possibility of irradiating a person with laser light (image light) when LD is used for the light source 10.

1. A projection image display apparatus comprising:
an image light generator configured to generate image light;
a projection optics configured to project the image light on a projection surface, the projection optics including a reflection mirror configured to reflect the image light emitted from the image light generator;
an image capture device configured to capture an image of a user facing the projection surface;
a first acquisition unit configured to acquire captured image data from the image capture device;
a second acquisition unit configured to acquire sample data independently of the captured image data; and
an image controller configured to control an image to be displayed on the projection surface on the basis of the captured image data and the sample data.

2. The projection image display apparatus according to claim 1, wherein the image controller superimposes a captured image formed of the captured image data on a sample image formed of the sample data, on the projection surface.

3. The projection image display apparatus according to claim 1, further comprising a size acquisition unit configured to acquire a size of a user to be included in the captured image,
wherein the image controller matches a size of the captured image and a size of the sample image with each other on the basis of the size of the user, on the projection surface.

4. The projection image display apparatus according to claim 2, further comprising a determination unit configured to determine a deviation degree between the captured image and sample image.

5. The projection image display apparatus according to claim 4, wherein the image controller displays the deviation degree on the projection surface.

6. The projection image display apparatus according to claim 2, further comprising a size acquisition unit configured to acquire a size of a user to be included in the captured image,
wherein the image controller matches a size of the captured image and a size of the sample image with each other on the basis of the size of the user, on the projection surface.
